(19) United States
(12) Patent Application Publication
(10) Pub. No.: US 2021/0065573 A1
(43) Pub. Date: Mar. 4, 2021

(54) ANSWER VALIDATION AND EDUCATION WITHIN ARTIFICIAL INTELLIGENCE (AI) SYSTEMS

(71) Applicant: INTERNATIONAL BUSINESS MACHINES CORPORATION, Armonk, NY (US)

(72) Inventors: Sarbajit K. RAKSHIT, Kolkata (IN); John M. Ganci, JR., Raleigh, NC (US); James E. Bostick, Cedar Park, TX (US); Martin G. Keen, Cary, NC (US)

(21) Appl. No.: 16/556,612

(22) Filed: Aug. 30, 2019

(51) Int. Cl. G09B 7/04; G06N 20/20; G09B 5/00; G09B 7/12; G06K 9/62

(52) U.S. Cl. CPC G09B 7/04; G06N 20/20; G06K 9/6263; G09B 7/12; G09B 5/00

(57) ABSTRACT

Systems and methods are disclosed for supplementing computer-generated results with third party feedback and educational information. In embodiments, a method includes: receiving user input from a user during an automated response-generating event; determining whether to present educational information with a result based on user data, wherein the educational information is information automatically generated by the computing device regarding a decision-making process utilized to generate the result; determining whether to present third party feedback with the result based on the user data, wherein the third party feedback includes information obtained from a human participant; and presenting a response to the user including the result, wherein content of the response is based on the determining whether to present the educational information with the result and the determining whether to present the third party feedback with the result.

### BACKGROUND

The present invention relates generally to computer question answering (QA) systems and, more particularly, to selectively providing results validation and education within an artificial intelligence (AI) system based on a user input.

Various AI systems are configured to provide an automated answer to a user based on a user input (e.g., voice input or text input). AI systems may assist users in making decisions in various situations. For example, an AI system may receive input parameters and provide a suggested decision to be taken for a scenario of the input. In instances, an AI system uses a knowledge base to generate a decision tree and provides a suggested action to the user based on the decision tree. In general, a decision tree is a decision support tool that uses a tree-like model of decisions and their possible consequences.

### SUMMARY

In a first aspect of the invention, there is a computer-implemented method including: receiving, by a computing device, user input from a user during an automated response-generating event, wherein the computing device is configured to automatically generate a result in response to the user input; determining, by the computing device, whether to present educational information with the result based on user data of the user, wherein the educational information is information automatically generated by the computing device regarding a decision-making process utilized by the computing device to generate the result; determining, by the computing device, whether to present third party feedback with the result based on the user data of the user, wherein the third party feedback comprises information obtained from a human participant in response to the user input; and presenting, by the computing device, a response to the user including the result, wherein content of the response is based on the determining whether to present the educational information with the result and the determining whether to present the third party feedback with the result.

In another aspect of the invention, there is a computer program product including a computer readable storage medium having program instructions embodied therewith. The program instructions are executable by a computing device to cause the computing device to: receive user input from a user during an automated response-generating event, wherein the computing device is configured to automatically generate a result in response to the user input; determine whether to present educational information with the result based on user data of the user, wherein the educational information is information automatically generated by the computing device regarding a decision-making process utilized by the computing device to generate the result; determine whether to present third party feedback with the result based on the user data of the user, wherein the third party feedback comprises information obtained from a human participant; determine whether the user input indicates time constraints with respect to the response; and present a response to the user including the result, wherein content of the response is based on the determining whether to present the educational information with the result, the determining whether to present the third party feedback with the result, and the determining whether the user input indicates time constrains with respect to the response.

In another aspect of the invention, there is system including a processor, a computer readable memory, and a computer readable storage medium. The system includes: program instructions to receive user input from a user during an automated response-generating event, wherein the computing device is configured to automatically generate a result in response to the user input, and wherein the user input comprises a question and user data indicating a status of the user; program instructions to determine to present educational information with the result based on user profile data, wherein the educational information is information automatically generated by the computing device regarding a decision-making process utilized by the computing device to generate the result; program instructions to determine that the user data does not indicate time constraints with respect to the response; program instructions to determine to present third party feedback with the result based on the determining that the user input does not indicate time constraints, wherein the third party feedback comprises information obtained from a human participant to supplement the result; and program instructions to present a response to the user including the result, wherein content of the response includes the educational information and the third party feedback. The program instructions are stored on the computer readable storage medium for execution by the processor via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 shows a flowchart of an exemplary method in accordance with aspects of the invention.

### DETAILED DESCRIPTION

The present invention relates generally to computer question answering (QA) systems and, more particularly, to selectively providing results validation and education within an artificial intelligence (AI) system based on a user input. According to aspects of the invention, a method is provided for an AI system to perform an analysis on a question being raised by a user, and determine if there are associated time constraints and/or value in involving humans in the decision-making (results-generating) process. In embodiments, an AI system's response to user input (e.g., a query) includes a decision tree of template defined information to educate the user in the AI system decision-making process (e.g., input parameters, solution options, recommended solutions, and pros and cons of solution options). In aspects, an AI system's response to user input presents a user with a decision tree at an appropriate level of detail based on time constraints of the user, as well as trusted crowd-sourced feedback for a combined AI and human response to the user input.

There are AI systems that suggest a decision or answer to a user input (e.g., a question), but do not teach the user about an end-to-end decision-making process (e.g., decision tree) utilized by the AI system to generate the result (e.g., a decision or answer). However, such AI systems do not provide users with information regarding what inputs are considered during the decision-making process, what alternative approaches (solutions) are available, the logic of the decision, or whether there are known negative consequences (e.g., side effects). If a user does not know why a decision is made, they may be less informed on a topic and lose decision-making skills and knowledge. Some users may be reluctant to trust the automated result/answer of an AI system, or would feel more confident in an AI system result/answer knowing that a trusted human can validate key aspects of the result/answer.

In aspects, an improved AI system is provided that selectively delivers human validation and education for an AI generated answer. In implementations, human validation and/or education is provided by the AI system based on whether time constraints are associated with the user/user input. In embodiments, an AI system is provided for determining how much information to present to a user based on a context of a problem being raised by the user or time constraints of the user. Advantageously, embodiments of the invention provide improvements to the functionality of an AI server/computing device and to the technical field of QA systems. More specifically, aspects of the invention utilize the unconventional steps of selectively providing educational information with an AI-generated result, and selectively providing human validation with respect to the AI-generated result.

In implementations, an AI system is configured to do one or more of the following: 1) respond to a user input with a decision tree of template-defined information to educate the user in the AI system decision-making process (e.g., input parameters, solution options, recommended solutions, pros/cons of solution options); 2) perform analysis on a question raised to determine a priority for the AI system response with an available time to execute a decision, and the detail level of decision-making based on the user's available time to receive a response (e.g., in the case that time is too constrained, the system may provide a post-execution response with information to explain the decision-making process to educate the user); 3) evaluate a question raised by the user to determine if one or more user's involvement in the decision-making process will strengthen the decision or have value in validating the decision by humans(s) (e.g., the system will involve the appropriate users in the decision-making process using crowd-sourced feedback for each step of the decision tree to present the user with the content to consume and learn); and 4) when a teaching mode is enabled, involve the user in decision-making in every step of the decision tree by asking the user questions to test knowledge (the system may validate the answer of the user to explain the decision-making process for learning purposes).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

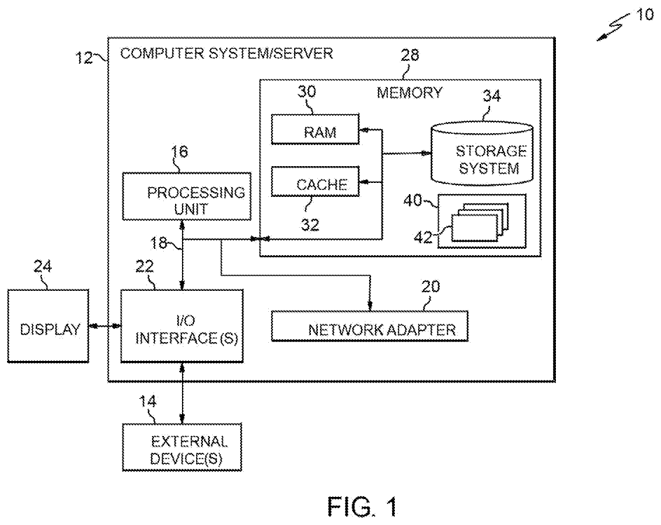

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

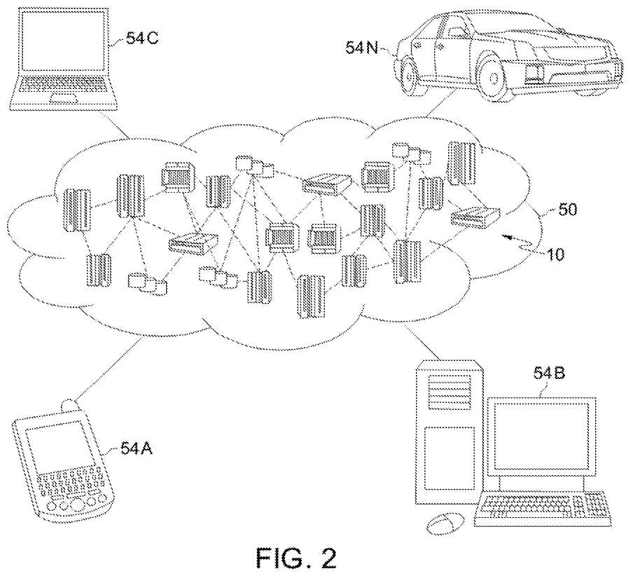

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

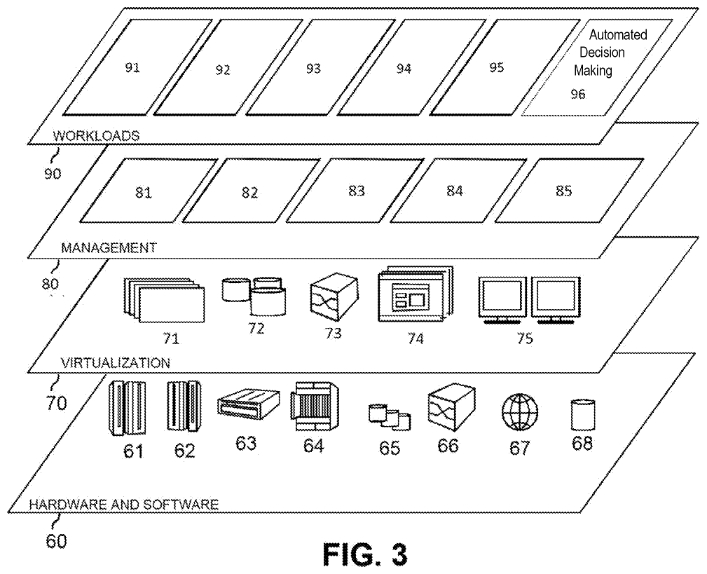

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below.

Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and automated decision-making 96.

Implementations of the invention may include a computer system/server 12 of FIG. 1 in which one or more of the program modules 42 are configured to perform (or cause the computer system/server 12 to perform) one of more functions of the automated decision-making 96 of FIG. 3. For example, the one or more of the program modules 42 may be configured to: determine if a user's query/question requires a solution or has a simple answer; determine if user education is desired for the query/question; determine if the query/question is time sensitive; determine if human feedback is desired to supplement or validate a response; select human participants to provide feedback; obtain the human feedback; determine if user education is desired regarding the query/question subject; determine if the query/question is time sensitive; and present results to the user with or without educational information (e.g., a decision tree) and/or supplemental human feedback.

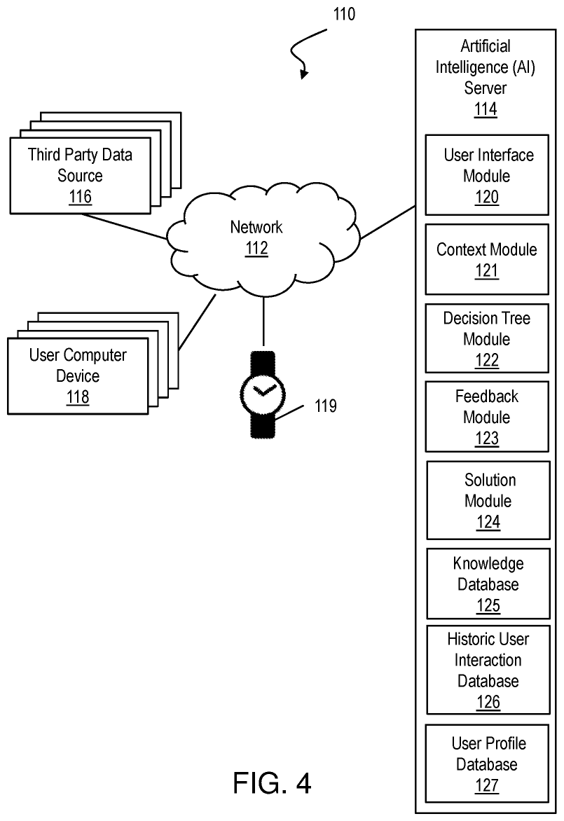

FIG. 4 shows a block diagram of an exemplary automated response-generating environment 110 in accordance with aspects of the invention. In embodiments, the environment 110 includes a network 112 interconnecting an AI server 114 with one or more third party data sources 116, one or more user computer devices 118, and one or more secondary user computer devices 119. The AI server 114 may comprise a computer system 12 of FIG. 1 and may be connected to the network 112 via the network adapter 20 of FIG. 1. The AI server 114 may be configured as a special purpose computing device that is part of a decision-making or QA service provider. For example, the AI server 114 may be configured to receive user inputs in the form of queries or questions from a plurality of remote participants and provide AI-generated results or answers to the user inputs, along with educational information and/or third party (human) feedback (e.g., validation) information.

The network 112 may be any suitable communication network or combination of networks, such as a local area network (LAN), a general wide area network (WAN), and/or a public network (e.g., the Internet). The third party data source 116 may be configured to receive human feedback requests from the AI server 114 and provide the AI server 114 with responses to the requests. The third party data source 116 may include components of the computing device 12 of FIG. 1 and may be in the form of a laptop device, tablet device, smartphone, desktop computer, or other computing device.

The user computer device 118 may be configured to provide user inputs (e.g., voice, text or video inputs) to the AI server 114, and obtain responses to the user inputs from the AI server 114. The user computer device 118 may include components of the computing device 12 of FIG. 1 and may be in the form of a voice assistant device (e.g., smart home device), laptop device, tablet device, smartphone, desktop computer, or other computing device. Additional secondary user computer devices indicated at 119 may also include components of the computing device 12 of FIG. 1, and may be configured to provide the AI server 114 with participant information such as image data (e.g., streaming video of the user), biological information of the user (e.g., heart rate of the user), or other information useful in determining a state of the user (e.g., stressed, anxious, etc.).

The AI server 114 may include one or more program modules (e.g., program module 42 of FIG. 1) configured to perform one or more functions described herein. In embodiments, the AI server 114 includes one or more of: a user interface module 120, a context module 121, a decision tree module 122, a feedback module 123, and a solution module 124. In embodiments, the AI server 114 includes one or more of: a knowledge database 125, a historic user interaction database 126 and a user profile database 127. In embodiments, the historic user interaction database may be combined with the user profile database 127, wherein historic user interaction data for a user is part of their user profile data.

In implementations, the user interface module 120 is configured to obtain user input data (e.g., questions) from one or more user computer devices 118 in the environment 110, and utilize computer-based question answering to provide responses (e.g., answers) to the one or more user computer devices 118. In implementations, the user input includes user data (e.g., real-time video of the user, heartrate data, etc.) from one or more user computer devices 118 and/or secondary user computer devices 119. In aspects, the user interface module 120 is configured to obtain user registration information from multiple participants and store the registration data in the user profile database 127.

In embodiments, the context module 121 of the AI server 114 is configured to analyze the user input for content and context. In implementations, the context module 121 performs one or more of the following: determining if a question or problem presented in the user input requires a solution (decision-making) or only a simple answer; determining if user education is desired for the question or problem; determining when to present educational information to the user; determining a knowledge gap of the user with respect to a decision event; determining if the question or problem is time sensitive; and determining if human feedback (e.g. validation) is desired with a response to the user input. The context module 121 may utilize decision tree data from the knowledge database 125, historic user interaction data from the historic user interaction database 126, and user registration information from the user profile database 127 in the implementation of certain method steps described herein.

In implementations, the decision tree module 122 is configured to obtain and store decision tree template information in the knowledge database 125. In aspects, the decision tree module 122 determines or creates a decision tree for use in generating a response (e.g., answer) to user input (e.g., a question).

In embodiments, the feedback module 123 is configured to determine when human feedback is required to supplement a response to user input, determine one or more third party sources to participate in the response to the user input, send feedback requests to the one or more third party sources, receive responses to the feedback requests, and provide the responses to the solution module 124 for sharing with the user.

In aspects, the solution module 124 is configured to analyze an input of a user received by the user interface module 120 and generate an answer/response to the input based on information received from the context module 121 (e.g., time sensitivity parameters). In implementations, the solution module 124 utilizes decision tree templates from the knowledge database 125, and third party feedback from the feedback module 123 (e.g., human answers to the user input) to implement method steps described herein.

In embodiments, the AI server 114 may include additional or fewer components than those shown in FIG. 4. In embodiments, separate components may be integrated into a single computing component or module. Additionally, or alternatively, a single component may be implemented as multiple computing components or modules. Moreover, the quantity of devices and/or networks in the environment 110 is not limited to what is shown in FIG. 4. In practice, the environment 110 may include additional devices and/or networks; fewer devices and/or networks; different devices and/or networks; or differently arranged devices and/or networks than illustrated in FIG. 4. Devices of the environment 110 may interconnect via wired connections, wireless connections, or a combination of wired and wireless connections.

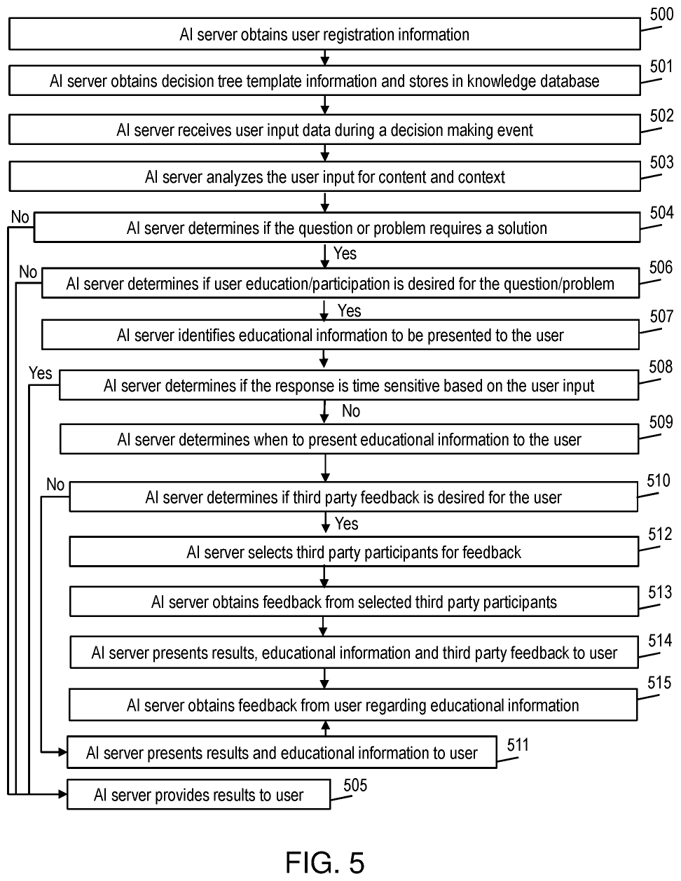

FIG. 5 shows a flowchart of an exemplary method in accordance with aspects of the present invention. Steps of the method may be carried out in the environment of FIG. 4 and are described with reference to elements depicted in FIG. 4.

At step 500, the AI server 114 obtains user registration information for a plurality of participants in the automated response-generating environment 110 of FIG. 4. In aspects, the AI server 114 is a QA server configured to perform a decision-making process (automatic response generating process) to generate a response (e.g., answer) to a user input (e.g., question). In embodiments, the AI server 114 provides users with user selectable system configuration options. In aspects, the user registration information includes information regarding user preferences for educational information (e.g., an education mode is enabled or disabled by the user), and information regarding the user's preferences for trusted human feedback (e.g., a feedback mode is enabled or disabled by the user). User registration information may include, for example, user identification information, user device information, permissions of the user, preferences of the user, or other user information which may be utilized by the AI server 114 in the implementation of embodiments of the invention discussed herein. Various user registration methods and tools may be utilized in the implementation of step 500, and step 500 is not intended to be limited to the examples discussed herein. In aspects, the user interface module 120 of the AI server 114 implements step 500.

At step 501, the AI server 114 obtains decision tree template information and stores the information in the knowledge database 72. Decision tree information may include multiple solution options for a particular subject and one or more advantages and/or disadvantages (e.g., pros and cons) for each of the multiple solution options. The term decision tree as used herein refers to a decision support tool that uses a tree-like model (e.g., tree-based classification model) of decisions and their possible consequences utilized in decision analysis (e.g., question answering). Various methods of generating decision tree templates may be utilized by the AI server 114 in the implementation of step 501. Embodiments of the invention are not intended to be limited to a specific means for obtaining/generating decision tree templates. In aspects, the AI server 114 generates decision tree template information over time based on user interactions with the AI server 114. The stored decision tree templates may be different for different topics and/or different users. In embodiments, the AI server 114 learns a user's preferences over time based on their historic user interactions, and can generate new knowledge tree templates based thereon. In implementations, the decision tree module 122 of the AI server 114 implements step 501.

At step 502, the AI server 114 receives user input data from a user computer device 118 during an automated response-generating event. The response-generating event may be a decision-making event. The term decision-making event as used herein refers to an event wherein the AI server 114 makes automated decisions or solves a problem to produce a result. In aspects, the AI server 114 utilizes decision tree templates or tools to generate a result during the decision-making event. The decision-making event may be a QA event wherein the AI server 114 automatically answers questions posed by the user in the user input. The user input data may be in the form of audio data, text data, video data, or combinations thereof. In aspects, the user input data is in the form of a query or question. In embodiments, the user input data includes user data such as biometric data, calendar data, or other user data (e.g., from a user computer device 118 and/or a secondary user computer device 119) indicating a status of the user for use in decision-making steps described herein. Various methods for receiving and processing user input data may be utilized in accordance with embodiments of the invention. In aspects, the user interface module 120 of the AI server 114 implements step 502.

At step 503, the AI server 114 analyses the user input for content and context. Various methods and tools for analyzing user input data may be utilized by the AI server 114 in the implementation of step 503, including natural language processing (NLP), image processing, voice to text processing and/or other tools. In implementations, the AI server 114 analyzes the user input to determine if the input comprises a question regarding a problem for which a solution (e.g., a means of solving a problem) is required, and to identify the user who submitted the user input (e.g., question). The identity of the user may be determined by the AI server 114 based on voice recognition techniques, facial recognition techniques, based on the user computer device 118 from which the input is received, login credentials of the user, or other techniques.

In implementations, the AI server 114 performs an analysis on a passive listening voice stream from a user computer device 118 to determine one or more questions being raised by a user. In embodiments, voice and tone analysis may be conducted by the AI server 114 to determine a status of the user (e.g., an emotional or physical state of the user such as elevated stress state or an elevated anxiety state), and correlate the status of the user with one or more time constraint parameters (e.g., levels of urgency of the user). In aspects, the AI server 114 analyzes image data for emotions and facial expressions (e.g., utilizing facial recognition tools and methods), and correlates the data with time constraint parameters. In implementations, image data may be analyzed by the AI server 114 to determine and recognize gestures of the user. In implementations, the user input may include user data from the user computer device 118 or a secondary user computer device 119 of the user, such as biometric data from a smartwatch. In aspects, the user data is analyzed at step 503 to determine a status of the user and correlate the status of the user with time constraint parameters. For example, biometric data from a user's smartwatch may be analyzed at step 503 for indicators of elevated stress or anxiety, and correlated with a level of urgency of the user (time constraint parameter). In implementations, the context module 121 of the AI server 114 implements step 503.

At step 504, the AI server 114 determines if the user input data indicates a problem for which a solution is required (e.g., decision-making is required), or conversely, whether the user input data indicates that only a simple answer is required. In implementations, when a question is presented in the user input data that requires the use of a decision tree having a predetermined complexity (e.g., more than one step), the AI server 114 determines that a computer-generated solution is required. Conversely, in implementations, when a question presented in the user input data requires a simple answer (e.g., the AI server 114 has one stored answer that matches the user's question or requires a decision tree having less than the predetermined complexity), the AI server 114 determines that a solution is not required. In aspects, the context module 121 implements step 504.

At step 505, if the AI server 114 determines that the user input does not require a solution at step 504, then the AI server 114 generates and provides a response to the user input including a result. The result may comprise an answer to a question presented in the user input. Various QA tools and methods may be utilized in the implementation of step 505. In aspects, step 505 is performed without the user of a decision tree, or with a decision tree having less than a predetermined complexity (e.g., two steps). One example of a user input that may result in step 505 is the simple question “What is the date today?”, wherein the AI server 114 responds according to step 505 with an answer comprising the date. In another example, a user may ask where a gas station is located, and the AI server 114 may respond with a simple answer based on stored data, as opposed to answering with a solution generated by the AI server 114 in response to the user input. The response may be in the form of a text-based response, an image-based response, an audio response, or combinations thereof. In aspects, the solution module 124 of the AI server 114 implements step 505.

At step 506, if the AI server 114 determines that the user input does require a solution at step 504, then the AI server 114 determines if user education regarding the decision-making process (e.g., question answering process) is desired with respect to the user input (e.g., question/problem). In aspects, the AI server 114 makes the determination of step 506 based on user profile information in the user profile database 127. For example, the AI server 114 may determine if the user has enabled an education mode, and if so, may determine that the user should be presented with additional educational information with the response. In implementations, the educational information is information automatically generated by the AI server 114 to educate the user with respect to the decision-making process utilized to obtain a result (e.g., answer). In embodiments a default setting for the AI server 114 is to provide education to the user. In implementations, the AI server 114 determines a user's level of interest in knowing the end-to-end decision-making process utilized to generate a response to the user input based on available data (e.g., historic user interaction information and user profile information), and determines whether the user requires education based on the user's level of interest (e.g., based on predetermined stored rules and threshold parameters). In embodiments, the AI server 114 can automatically enable an education mode for a user when it determines, based on historic user interaction data of the user, that the user has asked the same or similar types of question more than a predetermined threshold number of time. In implementations, the context module 121 of the AI server 114 implements step 506.

If the AI server 114 determines that user education regarding the response generating process is not desired, the AI server 114 provides a response to the user in accordance with step 505, without the addition of educational information (e.g., without an explanation of steps of a decision tree).

At step 507, the AI server 114 determines educational information to be presented to a user. The term educational information as used herein refers to information intended to educate the user regarding the decision-making process utilized by the AI server 114 to generate a result (e.g., answer) for a response. In embodiments, the educational information is different from the result, and supplements the result. For example, a result may be an answer to a questions presented in the user input data, while the educational information may be a decision tree utilized by the AI server 114 to generate the result.

In aspects, the AI server 114 determines a knowledge gap of the user with respect to the response process (e.g., steps of the decision tree utilized in generating a response). In aspects, the AI server 114 determines one or more portions of a decision-making process to present to the user (as educational information) based on the identified knowledge gap. In implementations, the AI server 114 determines, based on the identified user and user input (e.g., question), if the user would benefit from educational information based on historic interaction data of the user in the historic user interaction database 126 or the user profile database 127. In aspects, the AI server 114 identifies historic user interactions of the user related to the current response generating process (e.g., historic question answering sessions of the user utilizing the same or similar decision tree, regarding the same or similar topic of the user input, etc.) to determine a user's experience with similar decision-making processes, identifies if the user is aware of similar decision-making processes in the past, and determines whether the user is familiar with the end-to-end decision-making process (e.g., steps of the decision tree used in generating a response). Step 507 may be implemented simultaneously or concurrently with step 506.

In one example, a user asks the AI server 114 a question that has already been asked by the user and answered by the AI server 114 in the past. The past answer by the AI server 114 included educational information regarding how the answer was generated by the AI server 114 (e.g., the decision tree utilized by the AI server 114). In this example, the AI server 114 determines that the user would not benefit from the education information (e.g., from seeing the decision tree) based on fact that education information has been provided to them previously according to historic user interaction data in the historic user interaction database 126 or the user profile database 127.

In another example, the AI server 114 determines that the user is only aware of part of a result generating process (e.g., part of a decision tree) based on historic user interaction data, in which case the AI server 114 determines that the user may benefit from education information regarding the remining parts of the result generating process (e.g., remaining decision tree steps). Thus, in this example the AI server 114 identifies a knowledge gap of the user with respect to the response generating process being utilized (e.g., decision tree), and identify which decision-making steps/processes (e.g., steps of the decision tree) need to be communicated to the user (in the form of the educational information). In embodiments, the context module 121 of the AI server 114 implements step 507.

At step 508, the AI server 114 determines if the response or decision-making event is time sensitive based on the user input of step 502. In general, the process of the AI server 114 generating a response to the user input (e.g., generating a decision based on a decision tree) takes time, as does obtaining third party feedback for the user input. If the AI server 114 determines that a user's need for a response is time sensitive, the AI server 114 may not have time to generate educational information for the user or seek crowdsourced feedback in real time. In implementations, rules stored on the AI server 114 are utilized by the AI server 114 to determine when a decision-making event is time sensitive. In aspects, the AI server 114 can utilize predetermined threshold parameters in the rules to determine when a decision-making event is time sensitive or is not time sensitive.

In embodiments, the AI server 114 utilizes content and context data determined at step 503 to determine if there are any time sensitive parameters associated with the user input. For example, time sensitive parameters may include a topic of the user input that is time sensitive (according to predetermined rules), key words in the user input indicating that the user input is time sensitive (according to predetermined rules), sentiment analysis data indicating an emotional state of the user associated with time sensitivity (e.g., anxiety, stress, etc.), or biometric data associated with time sensitivity (e.g., elevated heartrate data, elevated blood pressure data, etc.). Rules regarding time sensitive parameters may be predetermined and/or generated by the AI server 114 over time for each user based on computer learning. In accordance with aspects of the invention, when the decision-making event is time sensitive, the AI server 114 may either present third party information and/or educational information after a time delay, may provide the user with third party information and/or educational information in a format that can be accessed at the user's convenience, or may forgo responding to the user input with third party information and/or educational information.

In one example, the user input comprises the question “The bridge ahead is flooded, what is the best route for getting home?” In this case, sentiment and content analysis of the user input indicates that an emergency situation (flooding) is being addressed, and the AI server 114 responds with an answer that does not include additional education information regarding the decision process utilized to produce the answer, or additional information regarding third party feedback (e.g., validation of the answer). In implementations, step 508 is implemented by the context module 121 and/or the solution module 124 of the AI server 114.

Optionally, at step 509, the AI server 114 determines when to present educational information to the user. In aspects, the AI server 114 determines whether to present educational information to a user without delay or with a delay. Step 509 may be implemented in conjunction with step 508. The AI server 114 may utilize user data such as calendar data, location data (e.g., global positioning system data) or other user data to determine a user's availability to review educational information. For example, if a user's calendar data indicates that the user is busy (e.g., in a meeting), the AI server 114 may determine based on user registration data that educational information regarding a response to the user's input should be emailed to the user for review at a later time.

At step 510, the AI server 114 determines if third party feedback (e.g., validation) is desired for the user. A user may wish to obtain human input regarding an AI-generated response in order to validate a result in the response or have more confidence in the response. In implementations, the user opts-in to a user feedback mode for the system, wherein trusted third party (human) sources provide feedback in a response to the user input. In embodiments, the third party feedback supplements the result, and may be the same or different from the result. In one example, a trusted third party source provides an answer to the user's question, wherein the user may compare the human-generated answer from the third party source to the AI-generated answer of the AI server 114. The third party feedback may provide a human-generated answer to a question presented with the user input that is the same as the computer-generated result of the AI server 114, thereby providing validation to the user regarding the computer-generated result. In implementations, the AI server 114 utilizes user profile information from the user profile database (e.g., an opt-in to a user feedback mode) in the determination of step 510. In embodiments, the feedback module 123 of the AI server 114 implements step 510.

At step 511, if the AI server 114 determines that third party feedback is not desired for the user at step 510, then the AI server 114 presents results (e.g., an answer) and educational information (e.g., a decision tree) to the user in response to the user input (e.g., question). Various QA tools and methods may be utilized in the implementation of step 511. In implementations, a decision tree is generated by the AI server 114 based a decision tree template in the knowledge database 125, and is presented as educational information to the user in the response. The response may be in the form of a text-based response, an image-based response, an audio response, or combinations thereof, for example. In aspects, the AI server 114 determines a decision tree template to utilize in the decision-making process based on the identification of the user, user preferences from the user profile database 127, and/or historic user interaction data from the historic user interaction database 126 or the user profile database 127. In aspects, the solution module 124 of the AI server 114 implements step 511.

At step 512, the AI server 114 selects third party participants to provide feedback to the user. In implementations, the AI server 114 accesses a database of third party participants associated with certain topics, subject matters, and/or users. In aspects, the AI server 114 matches one or more third party participants with user input data based on the content and contextual analysis of the user input and/or user profile data of the user. In one example, user input comprises a medical question, and the AI server 114 determines that a third party participant (doctor) who is listed as being a trusted source for medical questions matches the topic of the question. In this example, the AI server 114 selects the third party participant to provide trusted human feedback to the user with a response to the user's medical question. In implementations, the AI server 114 uses historic data analysis to predict if involving one or more third party participants will strengthen the results (e.g., answer to a question). In this case, the historic involvement of participants is considered during an end-to-end explanation of the decision-making process. The AI server 114 may identify one or more participants who have historically contributed to better results/decision such as by adding additional input information or scenario explanations, etc. In embodiments, the feedback module 123 of the AI server 114 implements step 511.

At step 513, the AI server 114 obtains feedback from the one or more third party participants selected at step 512. In embodiments, the AI server 114 sends the one or more third party participants selected at step 512 a request for feedback. In aspects, the request includes the user input, and the decision tree and/or response generated by the AI server 114 (generated in response to the user input). In implementations, the AI server 114 obtains one or more responses to the request(s) for feedback, and saves the responses in a database (e.g., in the historic user interaction database 126). In embodiments, the feedback module 123 of the AI server 114 implements step 513.

At step 514, the AI server 114 presents a response to the user, the response including a result, educational information, and third party feedback. The third party feedback may be feedback generated in response to the user input, or predetermined responses stored by the AI server 114 (e.g., in the historic user interaction database 126) that match the user input (e.g., the third party feedback is an answer to the same questions asked by the user in the user input). The educational information may be in the form of decision tree information generated based on a decision tree template from the knowledge database 125. In aspects, the identity of the user determines which decision tree will be utilized by the AI server 114 during the decision-making event to generate the response. The educational information may include input parameters utilized by the AI server 114 in the generation of a result, solution options, recommended solutions, and/or pros/cons of various solution options. Various QA tools and methods may be utilized in the implementation of step 511. In implementations, a decision tree is generated by the AI server 114 based a decision tree template in the knowledge database 125 and is presented as educational information to the user in the response. The response may be in the form of a text-based response, an image-based response, an audio response, or combinations thereof, for example.

In implementations, the response presented to the user may be one of several possible responses generated by the AI server 114. In aspects, the AI server 114 presents one of several possible results in the response based on a priority assigned to the possible results by the AI server 114. In implementations, if one of a plurality of results is selected by the AI server 114, validation of the priority of the results may be sought and provided by the third party participants as third party feedback. Similarly, in implementations, the AI server 114 presents one of several solutions (e.g., decision trees) utilized by the AI server 114 in the decision-making event based on a priority assigned to each solution. In aspects, a solution selected by the AI server 114 may be validated by third party participants.

In embodiments, the educational information and/or third party feedback of step 514 is presented separately from the results. For example, the educational information and/or third party feedback may be sent in a separate email in accordance with step 509, may be sent with the results in real time, or may be presented to the user after a predetermined time delay. In implementations, the educational information is presented to the user in a post-execution response (i.e. the educational information is generated and presented after the generation of the result). In aspects, the solution module 124 of the AI server 114 implements step 514.

Optionally, at step 515, the AI server 114 obtains feedback from the user regarding the educational information presented at step 511 or step 515. For example, the AI server 114 may present questions (e.g., a quiz) to the user to determine if they learned from the educational information. This may be based on the AI server 114 determining that user preferences in the user profile database 127 enable such communications. In embodiments, the AI server 114 involves the user in every step of the decision tree utilized to generate the result by asking the user questions to test their knowledge. The AI server 114 may validate the answer of the user to explain the decision-making process for learning purposes. In embodiments, the solution module 124 of the AI server 114 implements step 515.

The order of the steps in FIG. 4 may be different from the order presented. For example, steps 504, 506 and 509 may be performed concurrently, or in a different order than depicted in FIG. 4. Based on the above, embodiments of the invention enable the AI server 114 to respond to a user input by presenting the user with: 1) a result (solution), decision tree and crowdsourced feedback; 2) a result and decision tree; or 3) just a result. In implementations of the invention, the AI server 114 will: explain, based on the decision tree template information, the user input data that was considered in the decision-making process; identify alternate solutions to the problem/question presented in the user input; identify pros and cons of the alternate solutions; or provide other data to educate the user with respect to the decision-making process utilized to response to the user input data. In aspects, the user can make a more informed decision based on the educational information and/or trusted third party feedback regarding the decision tree.

It should be understood that, to the extent implementations of the invention collect, store, or employ personal information provided by, or obtained from, individuals (for example, user data obtained by the AI server 114), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving, by a computing device, user input from a user during an automated response-generating event, wherein the computing device is configured to automatically generate a result in response to the user input;
determining, by the computing device, whether to present educational information with the result based on user data of the user, wherein the educational information is information automatically generated by the computing device regarding a decision-making process utilized by the computing device to generate the result;
determining, by the computing device, whether to present third party feedback with the result based on the user data of the user, wherein the third party feedback comprises information obtained from a human participant in response to the user input; and
presenting, by the computing device, a response to the user including the result, wherein content of the response is based on the determining whether to present the educational information with the result and the determining whether to present the third party feedback with the result.

2. The computer-implemented method of claim 1, wherein the determining whether to present the educational information with the result comprises determining to present the educational information, and the content of the response includes the educational information.

3. The computer-implemented method of claim 1, wherein the determining whether to present the third party feedback with the result comprises determining to present the third party feedback, and the content of the response includes the third party feedback.

4. The computer-implemented method of claim 1, further comprising:
analyzing, by the computing device, the user input for content and context; and
determining, by the computing device, whether the user input indicates time constraints with respect to the response based on the analyzing,
wherein the determining whether to present the third party feedback is further based on the determining whether the user input indicates time constraints, and
wherein no third party feedback is provided in the content of the response when the user input indicates time constraints with respect to the response.

5. The computer-implemented method of claim 4, wherein the determining whether the user input indicates time constraints comprises determining that the user input indicates time constraints, the method further comprising presenting, by the computing device, the educational information or the third party feedback to the user in a second response separate from the response based on the time constraints.

6. The computer-implemented method of claim 1, further comprising:
selecting, by the computing device, the human participant from a plurality of human participants;
sending, by the computing device, a request to the human participant to provide feedback regarding the user input; and
receiving, by the computing device, the third party feedback from the human participant in response to the request.

7. The computer-implemented method of claim 1, wherein the educational information comprises at least one of the group consisting of: input parameters utilized by the computing device in the decision-making process; solution options; recommended solutions; and advantages and/or disadvantages of the solution options.

8. The computer-implemented method of claim 1, wherein a service provider at least one of creates, maintains, deploys and supports the computing device.

9. The computer-implemented method of claim 1, wherein the determining whether to present educational information with the result based on user data of the user and the determining whether to present third party feedback with the result based on the user data of the user, are provided by a service provider on a subscription, advertising, and/or fee basis.

10. The computer-implemented method of claim 1, wherein the computing device includes software provided as a service in a cloud environment.

11. A computer program product, the computer program product comprising a computer readable storage medium having program instructions embodied therewith, the program instructions executable by a computing device to cause the computing device to:
receive user input from a user during an automated response-generating event, wherein the computing device is configured to automatically generate a result in response to the user input;
determine whether to present educational information with the result based on user data of the user, wherein the educational information is information automatically generated by the computing device regarding a decision-making process utilized by the computing device to generate the result;
determine whether to present third party feedback with the result based on the user data of the user, wherein the third party feedback comprises information obtained from a human participant;
determine whether the user input indicates time constraints with respect to the response; and
present a response to the user including the result, wherein content of the response is based on the determining whether to present the educational information with the result, the determining whether to present the third party feedback with the result, and the determining whether the user input indicates time constrains with respect to the response.

12. The computer program product of claim 11, wherein the determining whether to present the educational information with the result comprises determining to present the educational information, and the content of the response includes the educational information.

13. The computer program product of claim 11, wherein the determining whether to present the third party feedback with the result comprises determining to present the third party feedback, and the content of the response includes the third party feedback.

14. The computer program product of claim 11, wherein:
the determining whether the user input indicates time constraints comprises determining that the user input indicates time constraints;
the determining whether to present the third party feedback is further based on the determining whether the user input indicates time constraints; and
no third party feedback is provided in the content of the response based on the determining that the user input indicates time constraints.

15. The computer program product of claim 14, wherein the program instructions further cause the computing device to present the educational information or the third party feedback to the user in a second response separate from the response based on the time constraints.

16. The computer program product of claim 11, wherein the program instructions further cause the computing device to:
select the human participant from a plurality of human participants;
send a request to the human participant to provide feedback regarding the user input; and
receive the third party feedback from the human participant in response to the request.

17. The computer program product of claim 11, wherein the educational information comprises at least one of the group consisting of: input parameters utilized by the computing device in the decision-making process; solution options; recommended solutions; and advantages and/or disadvantages of the solution options.

18. A system comprising:
a processor, a computer readable memory, and a computer readable storage medium;
program instructions to receive user input from a user during an automated response-generating event, wherein the computing device is configured to automatically generate a result in response to the user input, and wherein the user input comprises a question and user data indicating a status of the user;
program instructions to determine to present educational information with the result based on user profile data, wherein the educational information is information automatically generated by the computing device regarding a decision-making process utilized by the computing device to generate the result;
program instructions to determine that the user data does not indicate time constraints with respect to the response;
program instructions to determine to present third party feedback with the result based on the determining that the user input does not indicate time constraints, wherein the third party feedback comprises information obtained from a human participant to supplement the result; and
program instructions to present a response to the user including the result, wherein content of the response includes the educational information and the third party feedback,
wherein the program instructions are stored on the computer readable storage medium for execution by the processor via the computer readable memory.

19. The system of claim 18, further comprising:
program instructions to select the human participant from a plurality of human participants;
program instructions to send a request to the human participant to provide feedback regarding the user input; and
program instructions to receive the third party feedback from the human participant in response to the request.

20. The system of claim 18, wherein the educational information comprises at least one of the group consisting of: input parameters utilized by the computing device in the decision-making process; solution options; recommended solutions; and advantages and/or disadvantages of the solution options.
